(19) United States
(12) Patent Application Publication
(10) Pub. No.: US 2025/0026028 A1
(43) Pub. Date: Jan. 23, 2025

(54) END EFFECTOR FOR A ROBOTIC MANIPULATOR

(71) Applicant: Ocado Innovation Limited, Hatfield (GB)

(72) Inventor: Javid HAJIYEV, Toronto (CA)

(21) Appl. No.: 18/356,939

(22) Filed: Jul. 21, 2023

(51) Int. Cl. B25J 15/06; B65G 1/04; B65G 47/91

(52) U.S. Cl. CPC B25J 15/0616; B65G 1/0478; B65G 47/91

(57) ABSTRACT

An end effector for a robotic arm, the end effector comprising a suction cup and an inline filter assembly in fluid communication with the suction cup.

### TECHNICAL FIELD

The present disclosure relates generally to the field of picking stations for use in warehouses or fulfilment centers. Aspects relate to an end effector for use on a robotic manipulator assigned to such a picking station, the robotic manipulator and picking station, and a grid-based storage and retrieval system comprising the picking station.

### BACKGROUND

Online retail businesses selling multiple product lines, such as online grocers and supermarkets, require systems that are able to store tens or even hundreds of thousands of different product lines. The use of single-product stacks in such cases can be impractical, since a very large floor area would be required to accommodate all of the stacks required. Furthermore, it can be desirable only to store small quantities of some items, such as perishables or infrequently-ordered goods, making single-product stacks an inefficient solution.

PCT Publication No. WO2015/185628A (Ocado) describes a known storage and fulfilment system in which stacks of bins or containers are arranged within a framework structure. The bins or containers are accessed by load-handling devices operating on tracks located on the top of the frame structure. The load-handling devices are configured to lift bins or containers out from the stacks, and multiple load-handling devices can co-operate to access bins or containers located in the lowest positions of the stack. A system of this type is illustrated schematically in FIGS. 1 to 5 of the accompanying drawings.

FIG. 1 illustrates a framework structure 1 of a grid-based storage and retrieval system. The structure 1 comprises a number of upright members 3 supporting two sets of transversely arranged horizontal members 5, 7. The upright members 3 extend parallel to one another in the illustrated z-axis and stand orthogonally with respect to the horizontal members 5, 7. The first set of horizontal members 7 extend in the direction of the illustrated x-axis, while the second set of horizontal members 5 extend in the direction of the illustrated y-axis. The two sets of horizontal members 5, 7 form a grid pattern defining a plurality of grid cells. In the illustrated example, storage containers 9 are arranged in stacks 11, with each stack 11 being located beneath a respective grid cell.

FIG. 2 shows a large-scale plan view of a section of transverse track structure 13 forming part of the storage structure 1 illustrated in FIG. 1. The track structure 13 is located on top of the sets of horizontal members 5, 7. The track structure 13 may be provided by the horizontal members 5, 7 themselves (e.g., formed in or on the surfaces of the horizontal members 5, 7) or by one or more additional components mounted on top of the horizontal members 5, 7. The illustrated track structure 13 comprises x-direction tracks 17 and y-direction tracks 19, i.e., a first set of tracks 17 which extend in the direction of the illustrated x-axis and a second set of tracks 19 which extend in the direction of the illustrated y-axis. The tracks 17, 19 define apertures 15 at the centers of the grid cells. The apertures 15 are sized to allow storage containers 9 located beneath the grid cells to be lifted and lowered through the apertures 15. The x-direction tracks 17 are provided in pairs separated by channels 21, and the y-direction tracks 19 are provided in pairs separated by channels 23. Other arrangements of track structure 13 are also envisaged.

FIG. 3 shows a plurality of load-handling devices 31 moving on top of the storage structure 1 illustrated in FIG. 1. The load-handling devices 31, which may also be referred to as robots 31 or bots 31, are provided with sets of wheels to engage with corresponding x- or y-direction tracks 17, 19 to enable the bots 31 to travel across the track structure 13 and reach specific grid cells. The illustrated pairs of tracks 17, 19, separated by channels 21, 23, allow bots 31 to occupy or pass one another on neighboring grid cells without colliding.

As illustrated in FIG. 4, a bot 31 comprises a body 33 on which are mounted one or more components which enable the bot 31 to perform its intended functions. These functions may include moving across the storage structure 1 on the track structure 13 and raising or lowering storage containers 9 (e.g., from or to stacks 11) so that the bot 31 can retrieve or deposit storage containers 9 in specific locations defined by the grid pattern. The bot 31 further comprises first and second sets of wheels 35, 37 which are mounted on the body 33 and enable the bot 31 to move in the x- and y-directions along the tracks 17 and 19, respectively. In particular, two wheels 35 are provided on the shorter side of the bot 31 visible in FIG. 4, and a further two wheels 35 are provided on the opposite shorter side of the bot 31 (side and further two wheels 35 not visible in FIG. 4). The wheels 35 engage with tracks 17 and are rotatably mounted on the body 33 of the bot 31 to allow the bot 31 to move along the tracks 17. Analogously, two wheels 37 are provided on the longer side of the bot 31 visible in FIG. 4, and a further two wheels 37 are provided on the opposite longer side of the bot 31 (side and further two wheels 37 not visible in FIG. 4). The wheels 37 engage with tracks 19 and are rotatably mounted on the body 33 of the bot 31 to allow the bot 31 to move along the tracks 19. The bot 31 also comprises container-lifting means, generally designated by 39, configured to raise and lower containers 9. The container-lifting means 39 comprises four tapes or reels 41 which are connected at their lower ends to a container-engaging assembly 43. The container-engaging assembly 43 comprises engaging means (which may, for example, be provided at the corners of the assembly 43, in the vicinity of the tapes 41) configured to engage with corresponding features of the containers 9. For instance, the containers 9 may be provided with one or more apertures in their upper sides with which the engaging means can engage. Alternatively or additionally, the container engaging means may be configured to hook under the rims or lips of the containers 9, and/or to clamp or grasp the containers 9. The tapes 41 may be wound up or down to raise or lower the container-engaging assembly, as required. One or more motors or other means may be provided to effect or control the winding up or down of the tapes 41.

As can be seen in FIG. 5, the body 33 of the bot 31 has an upper portion 45 and a lower portion 47. The upper portion 45 is configured to house the one or more operation components (not shown) that enable the bot 31 to perform its intended functions, and the lower portion 47 is arranged beneath the upper portion 45. The lower portion 47 comprises a container-receiving space or cavity for accommodating at least part of a container 9 that has been raised by the container-lifting means 39. The container-receiving space is sized such that enough of a container 9 can fit inside the cavity to enable the bot 31 to move across the track structure 13 on top of storage structure 1 without the underside of the container 9 catching on the track structure 13 or another part of the storage structure 1. When the bot 31 has reached its intended destination, the container-lifting means 39 controls the tapes 41 to lower the container-gripping assembly 43 and the corresponding container 9 out of the cavity in the lower portion 47 and into the intended position. The intended position may be a stack 11 of containers 9 or an egress point of the storage structure 1 (or an ingress point of the storage structure 1 if the bot 31 has moved to collect a container 9 for storage in the storage structure 1). Although in the illustrated example the upper and lower portions 45, 47 are separated by a physical divider, in other embodiments, the upper and lower portions 45, 47 may not be physically divided by a specific component or part of the body 33 of the bot 31.

In some embodiments, the container-receiving space may not be within the body 33 of the bot 31. For example, in some embodiments, the container-receiving space may be adjacent to the body 33 of the bot 31, e.g., in a cantilever arrangement with the weight of the body 33 of the bot 31 counterbalancing the weight of the container to be lifted. In such embodiments, a frame or arms of the container-lifting means 39 may protrude horizontally from the body 33, and the tapes/reels 41 may be arranged at respective locations on the protruding frame/arms and configured to be raised and lowered from those locations to raise and lower a container into the container-receiving space adjacent to the body 33. The height at which the frame/arms is/are mounted on and protrude(s) from the body 33 of the bot 31 may be chosen to provide a desired effect. For example, it may be preferable for the frame/arms to protrude at a high level on the body 33 of the bot 31 to allow a larger container (or a plurality of containers) to be raised into the container-receiving space beneath the frame/arms. Alternatively, the frame/arms may be arranged to protrude lower down the body 33 (but still high enough to accommodate at least one container between the frame/arms and the track structure 13) to keep the center of mass of the bot 31 lower when the bot 31 is loaded with a container.

To enable the bot 31 to move on the different wheels 35, 37 in the first and second directions, the bot 31 includes a wheel-positioning mechanism for selectively engaging either the first set of wheels 35 with the first set of tracks 17 or the second set of wheels 37 with the second set of tracks 19. The wheel-positioning mechanism is configured to raise and lower the first set of wheels 35 or the second set of wheels 37 relative to the body 33, thereby enabling the load-handling device 31 to selectively move in either the first direction or the second direction across the tracks 17, 19 of the storage structure 1.

The wheel-positioning mechanism may include one or more linear actuators, rotary components or other means for raising and lowering at least one set of wheels 35, 37 relative to the body 33 to bring the at least one set of wheels 35, 37 out of and into contact with the tracks 17, 19. In some examples, only one set of wheels 35, 37 is configured to be raised and lowered, and the act of lowering the one set of wheels 35, 37 may effectively lift the other set of wheels 35, 37 clear of the corresponding tracks 17, 19, while the act of raising the one set of wheels 35, 37 may effectively lower the other set of wheels 35, 37 into contact with the corresponding tracks 17, 19. In other examples, both sets of wheels 35, 37 may be capable of being raised and lowered, advantageously meaning that the body 33 of the bot 31 stays substantially at the same height and therefore the weight of the body 33 and the components mounted thereon does not need to be lifted and lowered by the wheel-positioning mechanism.

As shown in FIG. 3, a plurality of identical load-handling devices 31 are provided, so that each load-handling device 31 can operate simultaneously to increase the throughput of the system. The system illustrated in FIG. 3 may include specific locations, known as ports, at which containers can be transferred into or out of the system. An additional conveyor system (not shown) is associated with each port, so that containers 9 transported to a port by a load-handling device 31 can be transferred to another location by the conveyor system, for example to a picking station (not shown). Similarly, containers 9 can be moved by the conveyor system to a port from an external location, for example to a container-filling station (not shown), and transported to a stack 12 by the load-handling devices 30 to replenish the stock in the system.

Each load-handling device 31 can lift and move one container 9 at a time. If it is necessary to retrieve a container 9 (“target container 9”) that is not located on the top of a stack, then the overlying containers 9 (“non-target containers 9”) must first be moved to allow access to the target container. This is achieved in an operation referred to hereafter as “digging.” During a digging operation, one of the load-handling devices 31 sequentially lifts each non-target container from the stack 11 containing the target container and places it in a vacant position within another stack 11. The target container can then be accessed by the load-handling device 31 and moved to a port for further transportation.

Each of the load-handling devices 31 is under the control of a central computer. Each individual container 9 in the system is tracked so that it can be retrieved, transported and replaced as necessary. For example, during a digging operation, the locations of each of the non-target containers is logged, so that the non-target containers can be tracked.

The system described with reference to FIGS. 1 to 5 has many advantages and is suitable for a wide range of storage and retrieval operations. In particular, it allows very dense storage of product, and it provides a very economical way of storing a wide range of different items in the containers, while allowing reasonably economical access to all of the containers when required for picking.

With reference to FIG. 6, the system may further comprise a robotic picking station, generally designated by 50, mounted on top of the structure 1, alongside the load-handling devices 31 (not shown). The robotic picking station 50 comprises a robotic manipulator 52 comprising a robotic arm 54 and an end effector 56 for releasably engaging a product to be manipulated, together with several designated grid cells 60, 62. The robotic manipulator 52 is mounted on a plinth 58 above a single grid cell 60 and, depending on its location on the structure 1, can be surrounded by up to eight other grid cells 62. In general, the robotic manipulator 52 is configured to pick an item or product from any one of the containers 9 located in one of the designated grid cells 62 and place it in a container 9 located in another one of the cells 62. The load-handling devices 31 collect containers 9 from, and deliver them to, the designated grid cells 62 as necessary. In this way, the robotic picking station 50 and the load-handling devices 31 work in conjunction to fulfil a customer order or redistribute products throughout the structure 1. The end effector 56 comprises a suction device 64 connected to a vacuum source in the form of a rotary vane pump (not shown). The vane pump forms part of a low pressure circuit configured to provide a vacuum pressure at the suction device 64, enabling it to attach to a product to be manipulated. The vane pump is positioned away from the top of the storage and retrieval structure 1 due to its size and weight, and so as not to occupy any grid cells. Instead, it is typically positioned at ground level, where it can be easily accessed, making its installation and maintenance more straightforward.

### SUMMARY

Accordingly, there is provided, in a first aspect, an end effector comprising a suction cup and an inline filter assembly in fluid communication with the suction cup.

Integrating the inline filter assembly into the robot end effector allows for a simpler construction of a robotic manipulator employing suction without the need for extra tubing, attachments, etc., mounted onto the robotic manipulator for the purpose of filtration.

In a second aspect, there is a suction cup assembly for a robot end effector, the suction cup assembly comprising a suction cup and a removable inline filter assembly comprising a connection element to connect to the robot end effector.

The inline filter assembly being removable means that it can be replaced, e.g., in the event that it becomes clogged with material and/or needs a new filter element, without needing to replace other components, such as the suction cup, that are still functional. Such removability can also speed up replacement in the event of a fault in the vacuum line, e.g., by making it easier to replace the inline filter assembly in situ, thus reducing downtime compared to a similar replacement in other systems.

### BRIEF DESCRIPTION OF THE DRAWINGS

These and other aspects will now be described, by way of example only, with reference to the accompanying drawing, in which:

FIG. 1 shows a schematic depiction of an automated storage and retrieval structure;

FIG. 2 shows a schematic depiction of a plan view of a section of track structure forming part of the storage structure of FIG. 1;

FIG. 3 shows a schematic depiction of a plurality of load-handling devices moving on top of the storage structure of FIG. 1;

FIGS. 4 and 5 show a schematic depiction of a load-handling device interacting with a container;

FIG. 6 shows a schematic depiction of a known robotic picking station;

FIGS. 7A and 7B show a side view and perspective view, respectively, of a robot end effector in accordance with an embodiment; and

FIGS. 8A and 8B show respective exploded views of the end effector shown in FIGS. 7A and 7B.

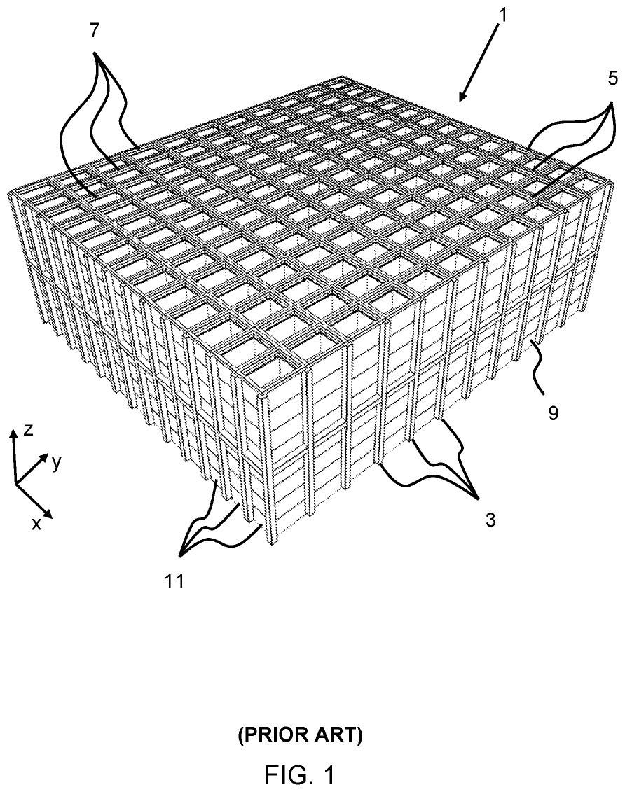

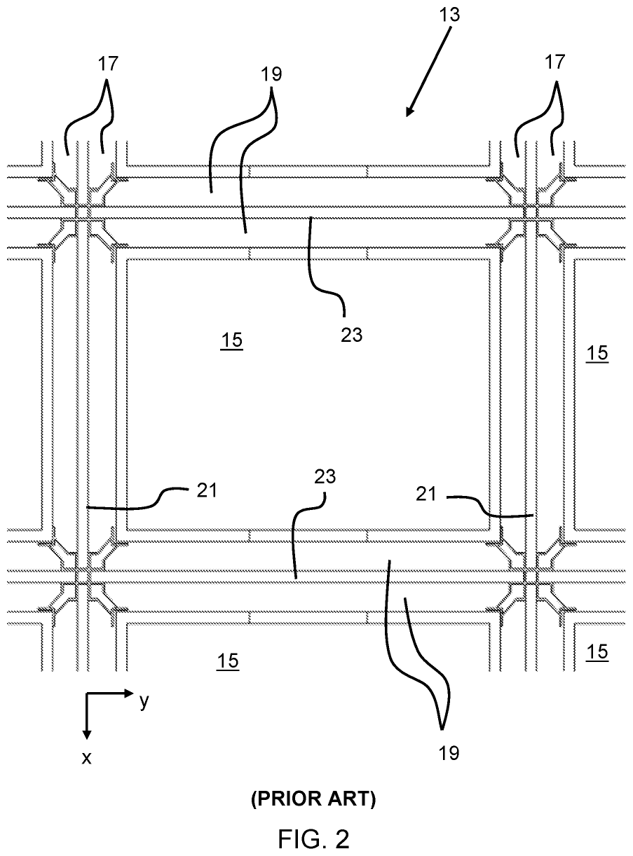

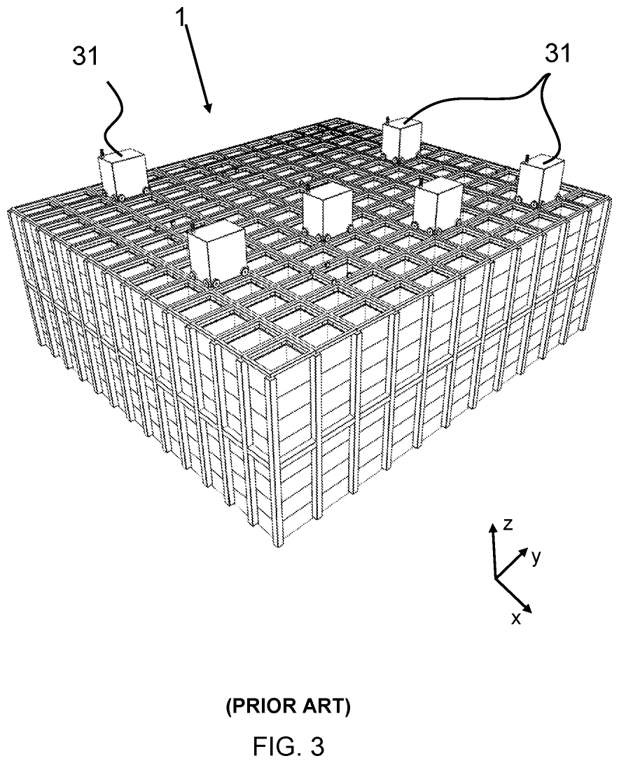

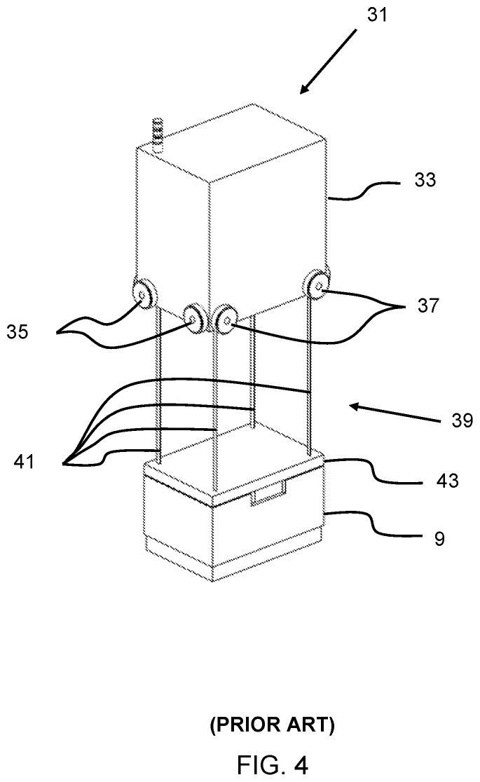

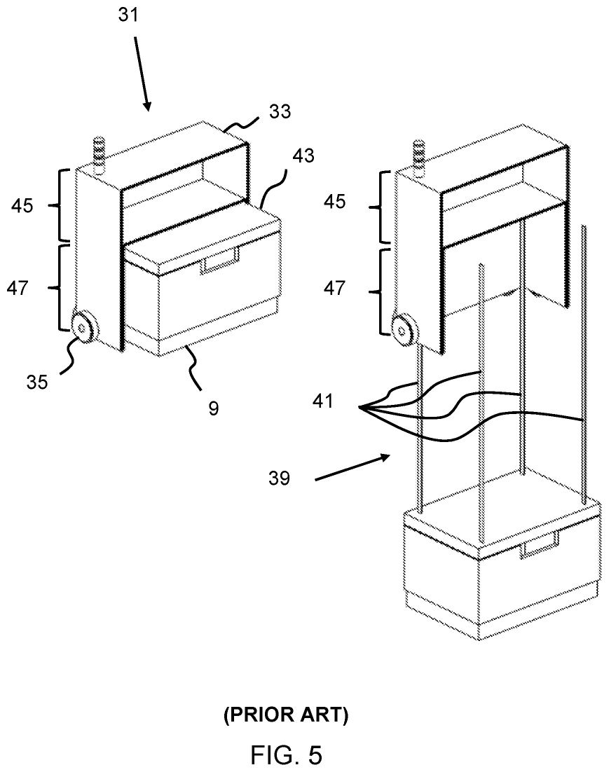

In the drawings, like features are denoted by like reference signs where appropriate.

### DETAILED DESCRIPTION

In the following description, some specific details are included to provide a thorough understanding of the disclosed examples. One skilled in the relevant art, however, will recognize that other examples may be practiced without one or more of these specific details, or with other components, materials, etc., and structural changes may be made without departing from the scope defined in the appended claims. Moreover, references in the following description to any terms having an implied orientation are not intended to be limiting and refer only to the orientation of the features as shown in the accompanying drawings. In some instances, well-known features or systems, such as processors, sensors, storage devices, network interfaces, fasteners, electrical connectors, and the like are not shown or described in detail to avoid unnecessarily obscuring descriptions of the disclosed embodiment.

Unless the context requires otherwise, throughout the specification and the appended claims, the word “comprise” and variations thereof, such as, “comprises” and “comprising” are to be construed in an open, inclusive sense that is as “including, but not limited to.”

Reference throughout this specification to “one,” “an,” or “another” applied to “embodiment,” “example,” means that a particular referent feature, structure, or characteristic described in connection with the embodiment, example, or implementation is included in at least one embodiment, example, or implementation. Thus, the appearances of the phrase “in one embodiment” or the like in various places throughout this specification are not necessarily all referring to the same embodiment. Furthermore, the particular features, structures, or characteristics may be combined in any suitable manner in one or more embodiments, examples, or implementations.

It should be noted that, as used in this specification and the appended claims, the use of the articles “a,” “an,” and “the” include plural referents unless the content clearly dictates otherwise. It should also be noted that the term “or” is generally employed in its sense including “and/or” unless the content clearly dictates otherwise.

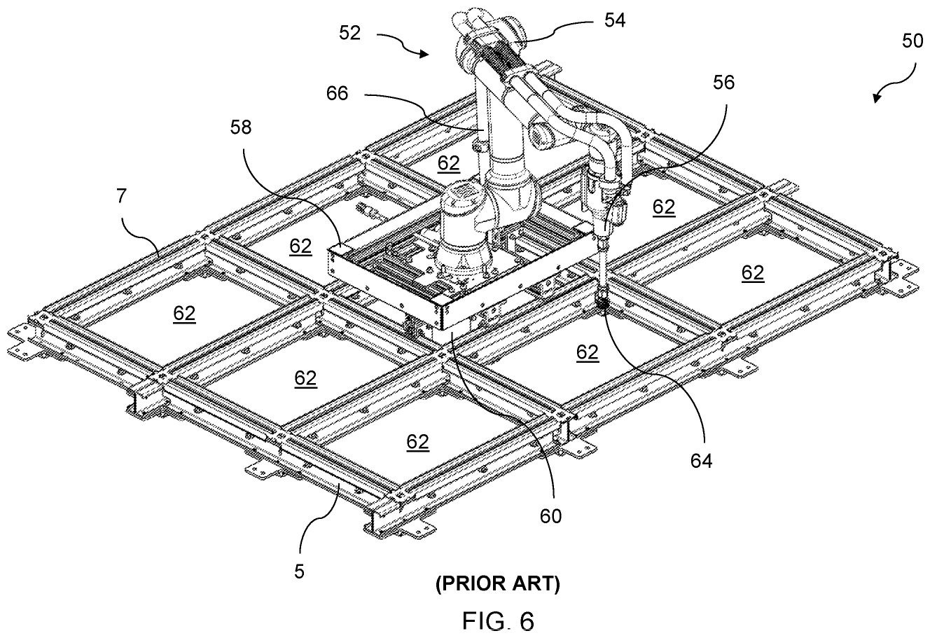

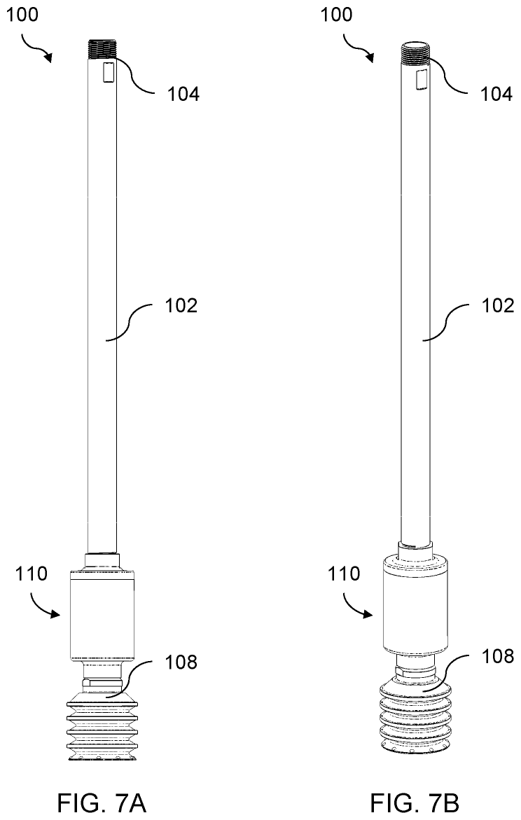

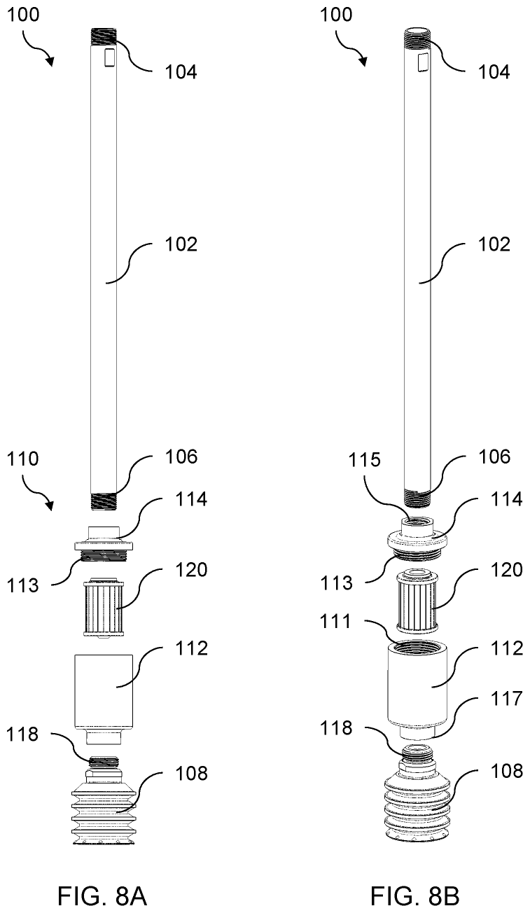

FIGS. 7A-7B and 8A-8B show an end effector 100 for a robotic arm, such as the one depicted in FIG. 6 as part of a robotic picking station 50. The end effector 100 comprises a suction cup 108 and an inline filter assembly 110 in fluid communication with the suction cup 108. For example, the inline filter assembly 110 is integrated as part of the end effector 100 for the robotic arm.

In other systems employing a low pressure circuit for providing vacuum pressure at a suction device, a vacuum filter may be connected to tubing, e.g., a hose, between the suction device and the vacuum source to isolate the vacuum source from debris picked up from the suction device. The present end effector 100, however, integrates the filter such that it need not be attached to the vacuum line elsewhere, e.g., to tubing mounted on the robot manipulator. Thus, a simpler construction of the robotic picking station can be achieved without extra tubing, attachments, etc., mounted onto the robotic arm.

The inline filter assembly 110 acts to filter material sucked into the vacuum line at the suction cup 108 which could damage the vacuum system. Placing the inline filter assembly 110 closer to the suction cup 108 reduces the effective length of vacuum line which is susceptible to clogging up from loose material in the environment sucked in by the suction cup 108. For example, in the context of a robotic picking station for picking grocery items, the integrated inline filter assembly 110 can protect the upstream vacuum system, e.g., including the vacuum source, from leaked liquids, semi-solids, colloids, gels, etc., that may be sucked into the vacuum line by the suction cup 108 during a picking operation. Integrating the inline filter assembly 110 into the end effector 100 such that it is located between the suction cup 108 and vacuum source in use can thus protect the vacuum source.

In the example shown in FIGS. 7A-7B and 8A-8B, the inline filter assembly 110 is axially aligned with the suction cup 108. Thus, as air is sucked into the suction cup 108 under vacuum pressure, it is directed into the filter assembly without deviating so that debris carried by the air can be filtered. In other examples, the inline filter assembly 110 and suction cup 108 may be axially misaligned due to the positional arrangement of the suction cup 108 relative to the end effector 100, e.g., the suction cup 108 may be angled for specific picking tasks.

The example end effector 110 shown in FIGS. 7A-7B and 8A-8B includes an elongate stem 102 in fluid communication with the inline filter assembly 110 and the suction cup 108. The inline filter assembly 110 is connected at a first end to the elongate stem 102 and at a second end to the suction cup 108. For example, the inline filter assembly 110 is connected between the elongate stem 102 and the suction cup 108. The elongate stem 102 is provided with a screw thread 104 at its upper end to secure the stem 102 to the robotic arm when connecting the end effector 100 thereto, e.g., at a flange plate at the end of the robotic arm. The external screw thread 104 is arranged to mate with another, internal, screw thread at the connection point, e.g., flange plate, on the robotic arm. In other examples, alternative mating elements may be used for this purpose instead of screw threads 104.

In an alternative example (not shown in the Figures), the inline filter assembly 110 is connected to a first end of the elongate stem 102 and the suction cup 108 is connected to a second end of the elongate stem 102. For example, the inline filter assembly 110 is connected between the elongate stem 102 and the robotic arm when the end effector 100 is attached to the robotic arm in use. In this example, the inline filter assembly 110 may include a connection element, e.g., a screw thread or other fastener, to connect to the robotic arm or an intermediate connector for connection to the robotic arm.

In both cases, locating the inline filter assembly 110 on the end effector 100 narrows down where an incident blockage in the vacuum line can be, i.e., to within the suction end effector 100 itself rather than any upstream conduits, tubing, etc., which can speed up resolution of the blockage. For example, in the case of a blockage, the end effector 100 can be removed and replaced with another one while the blockage is tended to, e.g., the filter is replaced. In the example shown in the Figures, i.e., where the inline filter assembly 110 is connected to the suction cup 108, the location of a blockage is further narrowed down to the suction cup assembly comprising the suction cup 108 and the inline filter assembly 110.

In some examples, the inline filter assembly 110 and the suction cup 108 are fixedly connected, e.g., such that separating them would either cause damage or make it difficult to put them back together in their original state. Similarly, the inline filter assembly 110 may be fixedly connected to the elongate stem 102 such that the whole end effector 100 comprises a single unit that is connectable to the robotic arm. As described, in the event of a blockage at the filter assembly 110 the whole end effector 100 can be disconnected from the robotic arm for inspection and replaced with a new end effector 100 on the robotic arm, thus reducing downtime compared to disconnecting a mounted filter and/or vacuum line in situ on the robotic arm.

Alternatively, as shown in the exploded views of FIGS. 8A-8B, the inline filter assembly 110 is removably connected to the suction cup 108. Thus, in the event of a blockage in the filter assembly 110, the filter assembly 110 can be removed from the suction cup 108, e.g., by unscrewing the two parts, and replaced. For example, the inline filter assembly comprises a connection element 115 (shown in FIG. 8B) to connect to at least one of the elongate stem 102, the robotic arm, or an intermediate connector for connection to the robotic arm. Thus, the inline filter assembly 110 is removable from the end effector 100, e.g., in the event that it becomes clogged with material from a picking operation, so that it can be replaced without needing to replace other components such as the suction cup 108. Again, such removability of components can speed up replacement in the event of a fault in the vacuum line, e.g., caused by a blockage or leak.

In the example shown in FIGS. 7A-7B and 8A-8B, the suction cup 108 and removable inline filter assembly 110 together form a suction cup assembly for the robot end effector 100. The removable inline filter assembly 110 includes a connection element 115, in the form of a screw thread, to connect to the robot end effector 100. For example, the stem 102 of the end effector 100 has a corresponding connection element 106, e.g., a corresponding screw thread, to connect to the inline filter assembly 110. The connection element 115 allows the inline filter assembly 110 to be disconnected from, and reconnected to, the end effector 100 such that it can easily be replaced.

In other examples, as described above, the connection element 115 is for connecting the removable inline filter assembly 110 to an intermediate connector which itself connects to the robotic arm in use. For example, the intermediate connector may allow for the whole end effector assembly, e.g., including the connector and end effector 100, to be disconnected from, and reconnected to, the robotic arm.

Returning to the example shown in FIGS. 8A-8B, the filter assembly 110 comprises a separable (or “dismantlable”) filter housing to house a filter element 120. The separable filter housing includes a body 112 and a removable cap 114 which, when connected together, enclose a space for the filter element 120. Optionally, a gasket (not shown) is arranged to help seal the joint between the body 112 and cap 114. The body 112 and cap 114 have corresponding connection elements 111, 113, e.g., screw threads or other releasable fastener, to connect together. In the specific example shown in FIGS. 8A-8B, the body 112 of the filter housing has a female, e.g., internal, thread and the cap 114 has the corresponding male, e.g., external, thread. Thus, in use, the filter housing can be disassembled by unscrewing the cap 114 from the body 112 to access the filter element 120, e.g., to replace it. Furthermore, any material that has clogged the filter assembly 110 can be removed by dismantling the housing 112, 114 to access the space inside the filter assembly 110. In the event of a blockage at the filter assembly 110, the housing 112 containing the filter element 120 can be removed from the cap 114 connected to the end effector 100 (e.g., at the stem 102) in situ and replaced with at least one of a new filter element and a new housing 112. The replacement housing 112 may be preassembled with its own suction cup 108, for example, such that the whole bottom assembly 108, 112 can be replaced in one operation.

The body 112 of the inline filter assembly 110 and the suction cup 108 also have corresponding connection elements 117, 118, e.g., screw threads or other releasable fastener, to connect together. In the specific example shown in FIGS. 8A-8B, the body 112 of the filter housing has a female, e.g., internal, thread and the suction cup 118 has the corresponding male, e.g., external, thread. Thus, the suction cup 118 can be removed from the filter assembly 110 when replacing at least part of the filter assembly 110, for example, so that the same suction cup 118 can be used with the replacement filter assembly 110.

The above examples are to be understood as illustrative. Further examples are envisaged. For instance, in the specific example of the end effector shown in the exploded view of FIGS. 8A-8B, all parts are releasably connectable to one another for quick and easy release when replacing or cleaning the parts. However, examples are envisaged in which some parts are releasably connectable while others are fixedly connected. For example, the filter housing 112 may be fixedly secured to the cap 114 of the filter assembly 110 while being releasably connectable to the suction cup 108, e.g., by reversible connectors 117, 118. Likewise, the cap 114 may be fixedly connected to the stem 102 of the end effector 100 while being releasably connectable to the filter housing 112. The nature of the connections between components can thus be selected based on the application. Furthermore, where any of the reversible connectors are present and comprise corresponding screw threads, the gender of the screw threads in the example shown in FIGS. 8A-8B may be reversed. Alternative reversible connections such as latches, clasps, twist-lock connectors are also envisaged.

The present disclosure describes examples of how the invention may be practiced, and it will be appreciated by those skilled in the art that a variety of approaches may be adopted without departing from the scope of the invention as defined by the appended claims.

It is also to be understood that any feature described in relation to any one example may be used alone, or in combination with other features described, such as in combination with one or more features of any other of the examples, or any combination of examples.

Various examples can be realized according to the following clauses:
1. An end effector for a robotic arm, the end effector comprising a suction cup and an inline filter assembly in fluid communication with the suction cup.
2. The end effector according to clause 1, wherein the inline filter assembly is axially aligned with the suction cup.
3. The end effector according to clause 1 or 2, wherein the inline filter assembly is connected to the suction cup.
4. The end effector according to clause 3, wherein the inline filter assembly is removably connected to the suction cup.
5. The end effector according to any one of clauses 1 to 4, wherein the inline filter assembly comprises a connection element to connect to at least one of: an elongate stem; the robotic arm; or an intermediate connector for connection to the robotic arm.
6. The end effector according to any one of clauses 1 to 5, wherein the end effector comprises an elongate stem in fluid communication with the inline filter assembly and the suction cup.
7. The end effector according to clause 6, wherein the inline filter assembly is connected to a first end of the elongate stem and the suction cup is connected to a second end of the elongate stem.
8. The end effector according to clause 6, wherein the inline filter assembly is connected at a first end to the elongate stem and at a second end to the suction cup.
9. A suction cup assembly for a robot end effector, the suction cup assembly comprising:
a suction cup; and
a removable inline filter assembly comprising a connection element to connect to the robot end effector.
10. The suction cup assembly according to clause 9, wherein the filter assembly comprises a separable filter housing to house a filter element.
11. The suction cup assembly according to clause 10, the separable filter housing comprising a body and a removable cap which, when connected together, enclose a space for the filter element.
12. The suction cup assembly according to clause 11, wherein the body and the removable cap comprise corresponding connection elements to connect together.
13. The suction cup assembly according to clause 12, wherein the corresponding connection elements comprise corresponding screw threads.
14. The suction cup assembly according to any one of clauses 9 to 13, wherein the connection element of the removable inline filter assembly is to connect the removable inline filter assembly to a stem of the robot end effector.
15. The suction cup assembly according to any one of clauses 9 to 13, wherein the connection element of the removable inline filter assembly is to connect the removable inline filter assembly to an intermediate connector for connection to a robotic arm.
16. A robot end effector comprising the suction cup assembly according to any one of clauses 9 to 15.
17. A robotic manipulator comprising the robot end effector according to clause 16.
18. A robotic picking station comprising the robotic manipulator according to clause 17.
19. A grid-based storage and retrieval system comprising a robotic picking station according to clause 18.
20. An inline filter assembly connectable to a robot end effector, the inline filter assembly comprising a separable filter housing having a body and a removable cap arranged to house a filter element when connected together,
the body having a first reversible connector to reversibly connect to a suction cup, and
the removable cap having a second reversible connector to reversibly connect to the robot end effector.
21 The inline filter assembly according to clause 20, wherein the second reversible connector is to reversibly connect to a stem of the robot end effector.
22. The inline filter assembly according to clause 21, wherein the body and the removable cap are connectable to each other by corresponding connectors.

1. An end effector for a robotic arm, the end effector comprising a suction cup and an inline filter assembly in fluid communication with the suction cup.

2. The end effector according to claim 1, wherein the inline filter assembly is axially aligned with the suction cup.

3. The end effector according to claim 1, wherein the inline filter assembly is connected to the suction cup.

4. The end effector according to claim 3, wherein the inline filter assembly is removably connected to the suction cup.

5. The end effector according to claim 1, wherein the inline filter assembly comprises a connection element to connect to at least one of: an elongate stem; the robotic arm; or an intermediate connector for connection to the robotic arm.

6. The end effector according to claim 1, wherein the end effector comprises an elongate stem in fluid communication with the inline filter assembly and the suction cup.

7. The end effector according to claim 6, wherein the inline filter assembly is connected to a first end of the elongate stem and the suction cup is connected to a second end of the elongate stem.

8. The end effector according to claim 6, wherein the inline filter assembly is connected at a first end to the elongate stem and at a second end to the suction cup.

9. A suction cup assembly for a robot end effector, the suction cup assembly comprising:
a suction cup; and
a removable inline filter assembly comprising a connection element to connect to the robot end effector.

10. The suction cup assembly according to claim 9, wherein the filter assembly comprises a separable filter housing to house a filter element.

11. The suction cup assembly according to claim 10, the separable filter housing comprising a body and a removable cap which, when connected together, enclose a space for the filter element.

12. The suction cup assembly according to claim 11, wherein the body and the removable cap comprise corresponding connection elements to connect together.

13. The suction cup assembly according to claim 12, wherein the corresponding connection elements comprise corresponding screw threads.

14. The suction cup assembly according to claim 9, wherein the connection element is to connect the removable inline filter assembly to a stem of the robot end effector.

15. The suction cup assembly according to claim 9, wherein the connection element is to connect the removable inline filter assembly to an intermediate connector for connection to a robotic arm.

16. A robot end effector comprising the suction cup assembly according to claim 9.

17. A robotic manipulator comprising the robot end effector according to claim 16.

18. A robotic picking station comprising the robotic manipulator according to claim 17.

19. A grid-based storage and retrieval system comprising a robotic picking station according to claim 18.
